(19) United States
(12) Patent Application Publication
(10) Pub. No.: US 2003/0105673 A1
(43) Pub. Date: Jun. 5, 2003

(54) Method for materials distribution

(76) Inventors: Bradley Jay Dunbaugh, Soquel, CA (US); James Robeson, Pacific Grove, CA (US); Randall Bosio, Gonzales, CA (US); Brian Edward Broggie, Carmel, CA (US)

Correspondence Address: ROTHWELL, FIGG, ERNST & MANBECK, P.C., 1425 K STREET, N.W., SUITE 800, WASHINGTON, DC, 20005, US

(21) Appl. No.: 10/177,223

(22) Filed: Jun. 24, 2002

Related U.S. Application Data
(60) Provisional application No. 60/334,123, filed on Nov. 30, 2001.

(51) Int. Cl. G06F 17/60

(52) U.S. Cl. 705/26

(57) ABSTRACT

A method for education test materials distribution allows education material suppliers to define a list of materials and construct test materials distribution algorithms for each material by selecting one or more predefined algorithms from a menu. The constructed algorithms are used to sort data in an enrollment database to generate shipping lists in fulfillment of test educational material orders. The system allows users to set an overage by type of material and/or site. The overage can be a percentage of the total materials sent, or a fixed amount.

This application claims the benefit of U.S. Provisional Application No. 60/334,123, filed Nov. 30, 2001.

### FIELD OF THE INVENTION

The present invention relates generally to a distribution method wherein the quantities of materials for distribution are determined by enrollment counts and, in particular, to a computerized method for education test materials distribution.

### BACKGROUND OF THE INVENTION

Previously, administration and operation of a materials distribution network required that personnel responsible for generating lists of materials to be distributed to one or more customer sites use software tools such as C, VisualBasic, Pascal, and other similar software development applications to create complex materials distribution rules. Such rules had to be recreated for each distribution requirement that is slightly different from previous distribution requirements. Such complex coding is time consuming and requires that personnel responsible for generating such distribution lists be versed in the coding software. Moreover, the complex coding is susceptible to coding errors that can lead to costly distribution errors in terms of numbers of items shipped, shipping destination, etc.

Thus, a need exists for a method of managing complex materials distribution requirements that eliminates the need to create a new complex code using a software coding application every time a slightly new distribution requirement is encountered.

### SUMMARY OF THE INVENTION

In accordance with the present invention, a novel method and software for materials distribution are disclosed. Such materials may comprise educational test materials. The system allows materials suppliers to define a list of materials and construct materials distribution algorithms for each material by selecting one or more predefined algorithms from a menu.

Examples of predefined algorithms include algorithms allowing a user to send a quantity of a selected material to all sites associated with a customer, to send a quantity of a selected material to specific types of the customer's sites, to send a quantity of a selected material to selected enrollment types (e.g., Braille students), to send a quantity of a selected material based on the quantity of another material sent, to send a quantity of a selected material to any number of selected enrollment types divided by the number of students at each site within the enrollment type, to send a quantity of selected material to any number of selected enrollment and group types, and to send a quantity of a selected material to any number of selected enrollment and group types and divide that by a number of students enrolled in the selected enrollment type and group type.

The constructed algorithms are used to sort data in an enrollment database to generate shipping lists in fulfillment of test educational material orders. The system allows users to set an overage by type of material and/or site. The overage can be a percentage of the total materials sent, or a fixed amount.

### BRIEF DESCRIPTION OF THE DRAWINGS

The invention will be described in detail with reference to the following drawings, in which:

FIG. 1 is a schematic diagram illustrating a computerized implementation of the materials distribution method according to the present invention.

FIG. 2 is a flowchart that provides an overall description of the method of materials distribution.

FIG. 3 is a computer screen shot encountered in a computerized implementation of the method of materials distribution that shows a sample contract with associated phases, parts, sites, and order batches.

FIG. 4 is a flowchart that provides an overview of the order generation procedure of the method of materials distribution.

FIG. 5 is a screen shot encountered in a computerized implementation of the method of materials distribution that shows a sample batch order screen with batch rules.

### DETAILED DESCRIPTION OF THE PREFERRED EMBODIMENTS

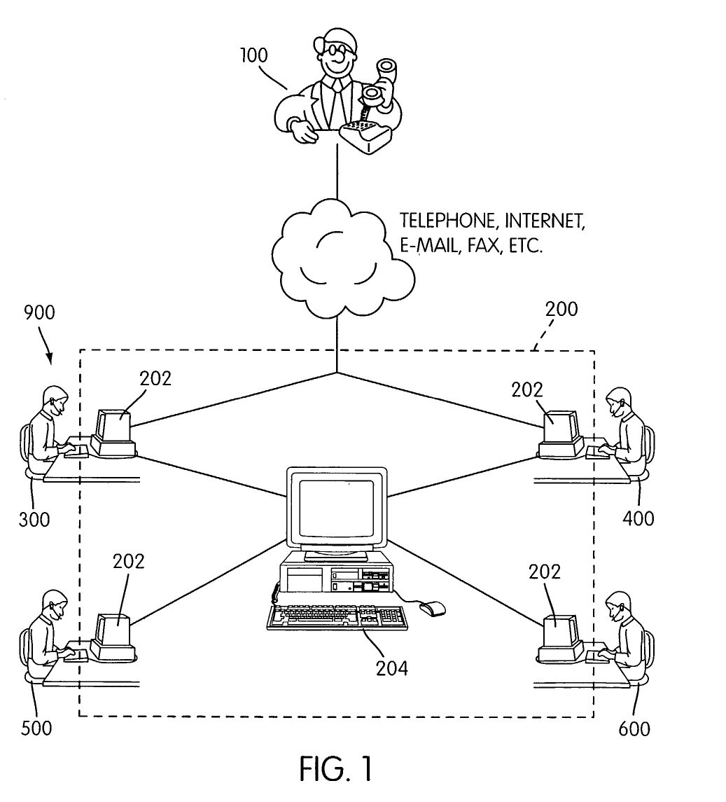

Referring now in detail to the drawings wherein like parts are designated by like reference numerals throughout. The method of the present invention can be implemented on a computer system, as will be described, controlled by appropriately programmed software stored in a computer-readable medium. There is illustrated in FIG. 1 an embodiment of a computerized system 200 for test materials distribution according to the present invention implemented over a distributed network such as a local area network (LAN). For purposes of illustration, the system 200 is shown as a plurality of remote computers 202 connected to a central computer 204 via a network, where by “computer” is meant a central processing unit and any hardware, software and peripheral devices needed to carry out assigned functions. It will be appreciated that the system can be implemented over any type of distributed network including, but not limited to, LANs, wide area networks (WANs) and the Internet. The system may also be implemented using a single computer if desired. The system 200 is operated by a service provider 900 such as an education test materials provider. The service provider 900 employs personnel such as program/project managers 300, customer representatives 400, fulfillment personnel 500, and manufacturing coordinators 600. These employees operate the shipping system 200 via the remote computers 202. A customer 100 may contact the service provider by any means including, but not limited to, telephone, internet, e-mail, or fax. Depending on the customer's needs, the service provider 900 preferably forwards the customer to either a program manager 300 or customer representative 400.

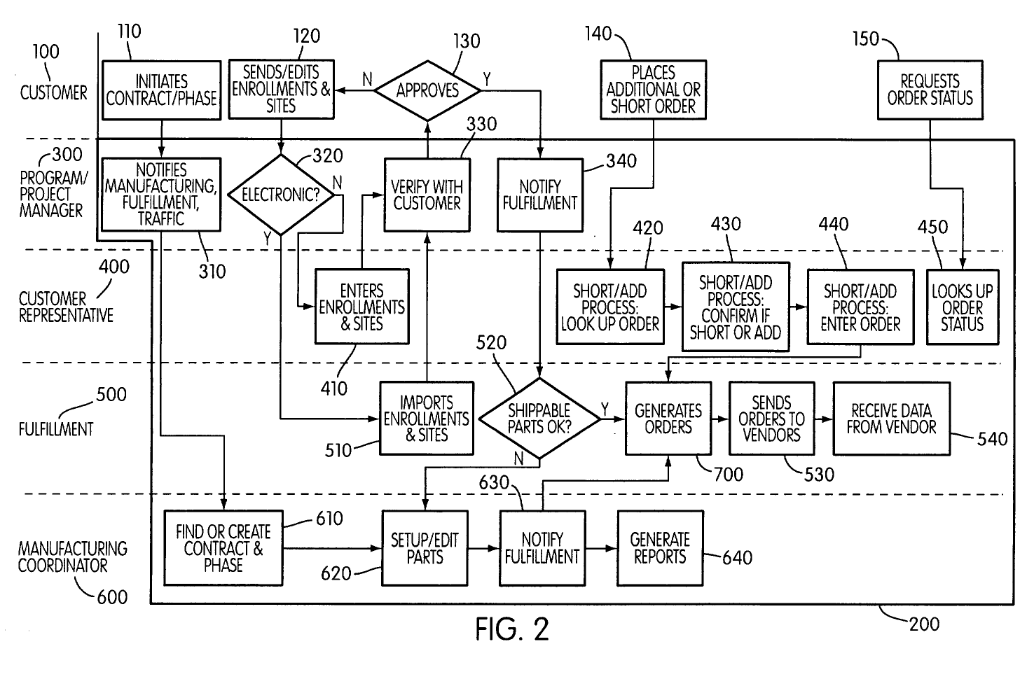

FIG. 2 is a flowchart illustrating a preferred operation of the test material distribution system 200. The flowchart is arranged in four rows, with each row representing actions initiated by the individual shown to the left of the row. Actions initiated by the customer 100 in relation to the system 200 are arranged in a row above the system flowchart. One or more of the system actions in a row can be initiated by other than the individual listed for that row. For example, the actions of the program manager and the customer representative can be performed by a single individual, etc.

A customer 100 contacts the program manager 300 in reference to a new contract or existing contract at step 110. In this context, “contract” means an agreement or arrangement whereby the service provider 900 will provide materials and related services for a particular customer 100 at one or more locations (i.e., sites) associated with the customer. For example, a contract may be an arrangement to provide educational and testing materials and related services to schools and school districts within the state of California's public school system. The program manager 300 notifies the manufacturing coordinator 600 and the fulfillment personnel, or department, 500 (hereinafter simply “fulfillment” for brevity) at step 310. The manufacturing coordinator 600 finds or creates a contract for the customer 100 at step 610. The contract may be separated into relevant phases, for example, “fall examination cycle” and “spring examination cycle.” If the contract contains phases, the manufacturing coordinator 600 finds or creates them at step 610.

For each phase, the manufacturing coordinator 600 enters parts into the shipping system 200 or edits existing parts at step 620. By “parts” is meant “components” which are individual pieces of materials to be provided to the customer in accordance with the contract, such as test instructions and forms, and “shippable parts” which are one or more components that are put together and shipped as a unit to the customer. Entering or editing parts preferably results in a list of components and an indication how they are bundled, if at all, as shippable parts. For example, the components required for the fall examination cycle may include middle school test booklets, high school test booklets, middle school answer sheets, high school answer sheets, test administrator guides, answer sheet envelopes, and the like.

When parts are added or edited for each contract and phase, the system 200 notifies fulfillment 500 at step 630 that the order is ready for generation, and fulfillment generates an order at step 700, which will be described in more detail below. Additionally, the manufacturing coordinator can generate part reports at step 640.

When the contract and phases for each customer 100 are established, the customer 100 sends site and enrollment data to the service provider at step 120. For the example of a school system, sites may be individual schools or districts. Enrollment data typically includes the grade levels at each site as well as student enrollments for each grade level and may also include enrollment data for individual classes within grade levels. As depicted at step 320, the customer may provide site and enrollment data manually or electronically (e.g., via e-mail, dial-up connection, electronic storage media, or the like). If provided electronically, fulfillment 500 imports the enrollment data at step 510 and the program manager 300 then verifies the data with the customer at step 330. If provided manually, the customer representative 400 enters the enrollment and site data at step 410 and the program manager 300 verifies it with the customer at step 330. As depicted at step 130, if the customer approves the enrollment and site data, the system 200 notifies fulfillment at step 340. If further changes are required the customer provides the corrected information as described above at step 120. Assuming the customer 100 has approved the enrollment and site data, fulfillment 500 checks the data against the existing definition of shippable parts at step 520 to ensure the quantities of parts are correct and, if the quantities are wrong, sends the data to the manufacturing coordinator 600 to make necessary corrections at step 620. Once the shippable part data is set up correctly, fulfillment generates the order at step 700.

When fulfillment 500 has generated the order at step 700, the order is sent to the vendor at step 530. The vendor maintains the product inventory. When the vendor receives the customer order, it picks and packs the requested parts and ships them to the customer 100 at the appropriate customer site(s). Once the order is shipped, the vendor notifies fulfillment at step 540.

In another embodiment of the present invention, the customer 100, after receiving its order, can contact the service provider 900 and place add/short orders at step 140. An add order is when a customer's order matches what is on their packing list, and they are ordering additional parts. A short order is an order in which the customer receives fewer parts than what is listed on the packing list.

When the customer 100 contacts the service provider 900 to make an add/short order, the customer representative 400 uses the shipping system 200 to retrieve the original order at step 420. The customer representative 400 confirms whether the new order is a short or an add order at step 430 and enters information for the new order at step 440. When the new order is entered, fulfillment 500 is notified that the order is ready for generation at step 700. In this embodiment, the customer need interact with only one individual in order to submit the add or short order.

In yet another embodiment of the present invention, the customer 100 contacts a customer representative at step 150 in order to determine order status. The customer representative 400 uses the shipping system 200 to locate the order and order tracking number at step 450. The customer representative 400 then accesses the internet website of the shipping company, enters the tracking number, determines the shipping status, and provides this information to the customer 100.

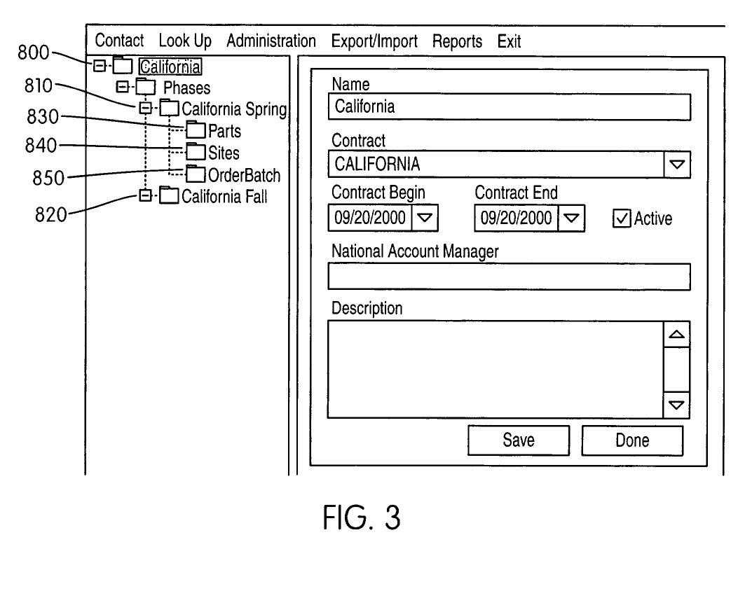

FIG. 3 is a screen shot showing information displayed by the system 200 when finding or creating a contract and/or phases. In the example shown, the contract, phases, etc., are displayed using a directory structure. The root directory 800 is the contract (e.g., California), and the subdirectories 810 and 820 are the phases (e.g., California Spring and California Fall, respectively). Folders 830, 840 and 850 for parts, sites, and order batches, respectively, are depicted for the California Spring phase. Each phase preferably has similar folders.

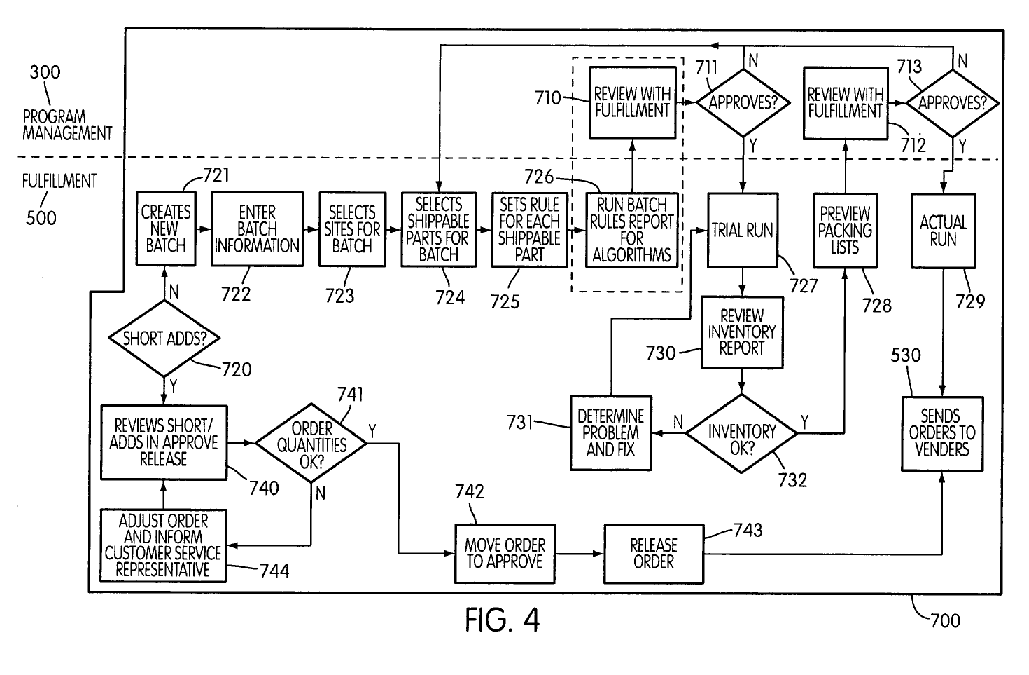

FIG. 4 is a flowchart illustrating operation of the order generation routine 700. Initially, fulfillment 500 determines whether the batch order is an add/short order at step 720.

If the order is an add/short order, fulfillment 500 reviews the order at step 740 and determines if the order quantities are correct at step 741. If the quantities are incorrect, fulfillment adjusts the order and informs the customer representative 400 at step 744. Fulfillment then reviews the corrected order at step 740. If the quantities are correct, fulfillment 500 approves the order at step 742 and releases it at step 743. The order is then sent to the vendor, as described above in step 530.

If the order is not an add/short order, fulfillment 500 creates a new batch order at step 721, enters batch information at step 722, and selects a site (or sites) where the order will be sent at step 723. For each site, fulfillment 500 selects the parts required for the order at step 724 from the list of parts created by the manufacturing coordinator 600, as described above at step 620. This step is desirable because not every site will require every single component added to the contract/phase. For example, when a batch order is created in order to fulfill a contract for educational test materials for the fall examination phase, all parts added for that phase are preferably listed on the batch order screen. However, middle schools will not require high school examination materials, and high schools will not require middle school examination materials. Accordingly, parts are preferably assigned to each site to reflect their individual needs.

When shippable parts have been selected for the batch order, fulfillment 500 selects a rule at step 725 for each shippable part at a site. A “rule” is a distribution algorithm defining parts to be delivered in terms of other parameters relating to the order, or request. By selecting an appropriate rule, the system automatically determines the quantity of each shippable part to ship to each site. Once the rules are selected for each shippable part, fulfillment 500 generates a batch rule report at step 726, which is reviewed at step 710 for program management approval at step 711. If changes are necessary, the order is sent back to fulfillment for correction at step 724. If program management 300 approves the report at step 711, a trial run for the order is conducted at step 727. Fulfillment 500 reviews the trial run inventory report at step 730 and determines if the inventory review is correct at step 732. Any required corrections are made at step 731 and a new trial run is conducted as described in step 727. If the inventory report is correct, fulfillment generates order packing lists at step 728 and reviews them with program management at step 712 for program management approval at step 713. If changes are necessary, the order is sent back to fulfillment for correction at step 724. If program management approves the batch order at step 713, fulfillment generates the actual order at step 729 and sends the batch order to the vendor as described above at step 530.

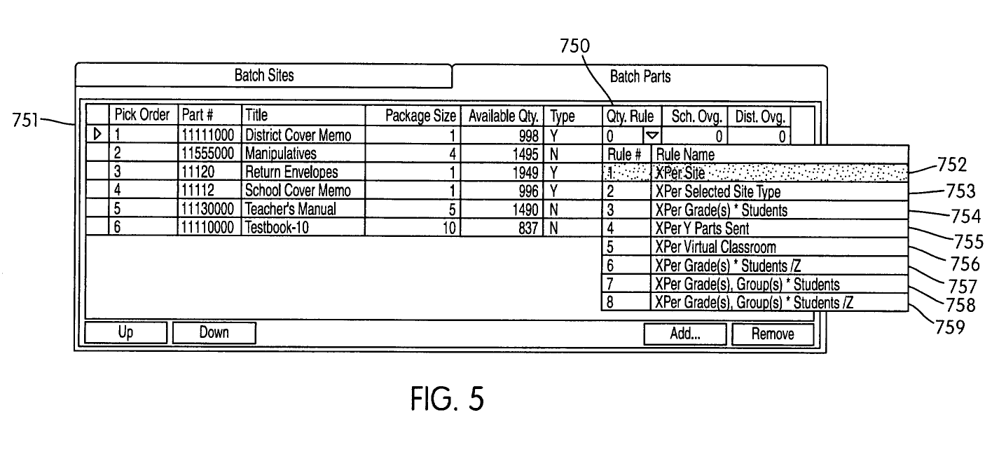

FIG. 5 is a screen shot illustrating a preferred method of assigning rules (set 725) to each shippable part in a batch. In the current example, fulfillment 500 selects a batch/quantity rule 750 for a part (e.g., the district cover memo in field 751) using a drop-down menu. Other methods of selection can be used including, but not limited to, pop-up windows and menus allowing “point-and-click” or manual entry, and defined keystrokes. In the preferred embodiment, the system will display one or more of the following rules for each part for selection:

1. X Per Site (shown at field 752): Allows the user to send a quantity (X) of the selected part to one or more sites, regardless of the type of sites. For example, this rule could be used to send a “Welcome to the Test!” cover memo to site, e.g., each school.

2. X Per Selected Site Type (shown at field 753): Allows the user to send a quantity (X) of a selected part to specific types of sites, such as schools or school districts. For example, this rule could be used to send one type of memo to schools, and a different type of memo to school districts.

3. X Per Enrollment Type(s) (shown at field 754): Allows the user to send a quantity (X) of a selected part to selected enrollment types. The enrollment types of this rule is flexible and can be modified to fit the specific needs of the customer, supporting more than just grades. Examples of enrollment types include “Mrs. Smith's Class,” “Braille Students,” or any number of variables that are unique to the customer's needs. For example, this rule could be used to send a correct quantity of 10th Grade Test Booklets only to schools where there are 10th Grade enrollments.

4. X Per Y Parts Sent (shown at field 755): Allows the user to send a quantity (X) of a selected part based on the quantity (Y) of another part sent. For example, this rule could be used to send a test coordinator's guide for every 20 student tests sent.

5. X Per Virtual Classroom (shown at field 756): Allows the user to send a quantity (X) of the selected part to each virtual classroom.

6. X Per Enrollment Type(s) divided by Z (shown at field 757): Allows the user to send a quantity (X) of a selected part to any number of selected enrollment types, divided by the number of students (Z) at each site within the enrollment type. Again, the enrollment types can be modified to fit the specific needs of the customer. For example, this rule could be used to send a “Third Grade Teacher's Guide” to each school with third grade enrollments, divided by the average third grade class size so that there was one guide for each third grade teacher.

7. X Per Enrollment Type Per Group Type (shown at field 758): Allows the user to send a quantity (X) of a selected part to any number of selected enrollment and group types. Both enrollment types and group types can be modified to fit the specific needs of the customer. For example, this rule could be used to send a third grade Form A Test to one enrollment type/group, and a third grade Form B Test to a different enrollment type/group.

8. X Per Enrollment Type Per Group Type Divided by Z (shown at field 759): Allows the user to send a quantity (X) of a selected part to any number of selected enrollment and group types divided by a number of students (Z) enrolled in each enrollment and group type. For example, this rule can be used to send a third grade Form A Teacher's Guide to one enrollment type/group, and a third grade Form B Teacher's Guide to a different enrollment type/group divided by the number of students in each enrollment type/group so that there is one Teacher's Guide for each teacher of the associated enrollment type group.

In addition to the pre-defined rules described above, the system 200 preferably allows each rule to be further refined using Structured Query Language (SQL) to identify specific sites with a unique attribute. Such sites may receive parts that are completely different from the general population of sites. To accommodate users that do not know SQL, the system 200 preferably includes a query builder that is available from within each rule, for example in a pop-up window, allowing the user to use “point and click” methods to create their selection criteria. Once the query is built, it can be tested to ensure that the desired result is achieved.

The rules work on presorted lists of delivery sites. This allows the shipping system 200 to support any unique sorting requirement requested by the customer 100. Such sorts include sorting from largest district to smallest for shipping in that order, sorting by route codes, or sorting by school types.

Additionally, each rule allows the user to select either a fixed quantity or fixed percentage of “overage” to include with each part order. For example, if a particular site has a third grade enrollment of 100 students, the user could select the “X Per Enrollment Type(s)” rule for “third grade examinations.” This will automatically cause 100 third grade examinations to be added to the batch order for that site. If the user wishes to ensure that the site gets an overage of 10%, they can either specify an overage quantity of “10” or an overage percentage of “10%.” If an overage quantity is selected, the overage included with the order will remain the same regardless of changes to enrollment data. If an overage percentage is selected, changes to enrollment data will result in a corresponding change in the overage included with the order.

From the above, it will be appreciated that the present invention overcomes the prior limitations that required the user to write and reuse computer code for each order by employing built-in “point and click” distribution algorithms that allow the user to automatically assign distribution quantities according to preselected criterion.

All functions shown in FIGS. 2 and 4 can be performed on-line using the system 200. Alternatively, some of the functions, such as verifying information with the customer, can be performed offline using telephones and other modes of communication.

Although a preferred embodiment is specifically illustrated and described herein, it will be appreciated that modifications and variations of the present invention are covered by the above teachings and within the purview of the appended claims without departing from the spirit and intended scope of this invention. In particular, it is envisaged that the present invention could be used by any distributor who must determine quantities for distribution based on enrollment counts (e.g., number of students), such as education materials suppliers, insurance providers, and health care providers.

What is claimed is:

1. A method for fulfilling a customer request for materials, said method comprising:
defining a list of materials necessary to fulfill said request;
constructing a materials distribution algorithm for each material, said materials distribution algorithm being constructed by selecting a predefined algorithm from a menu; and
fulfilling said request by sending quantities of said materials as determined by each said materials distribution algorithm.

2. The method of claim 1, further comprising determining one or more sites from a plurality of sites associated with said customer to which said quantity of materials will be sent.

3. The method of claim 1 wherein said method is implemented using a computer system.

4. The method of claim 3 wherein said computer system is a stand-alone computer system.

5. The method of claim 3 wherein said computer system is part of a distributed network.

6. The method of claim 5 wherein said distributed network is implemented using at least one of (a) a local area network, (b) a wide area network, and (c) the Internet.

7. The method of claim 1 wherein said menu includes at least one of the following predefined materials distribution algorithms:
(a) X per site;
(b) X per selected site type;
(c) X per enrollment type;
(d) X per Y parts sent;
(e) X per virtual classroom;
(f) X per enrollment type divided by Z;
(g) X per enrollment type per group type; and
(h) X per enrollment type per group type divided by Z,
wherein “X” is a number of materials defined by the predefined materials distribution algorithm, “Y” is a number of other materials used as a parameter in the predefined materials distribution algorithm, and “Z” is a number of individuals enrolled in the enrollment type or group type.

8. The method of claim 1, wherein said materials comprise educational testing materials.

9. The method according to claim 8, wherein said educational test materials comprise one or more items selected from the group comprising middle school test booklets, high school test booklets, middle school answer sheets, high school answer sheets, test administrator guides, answer sheet envelopes, and teacher guides.

10. The method according to claim 7, wherein said types of sites comprise schools or school districts.

11. The method according to claim 7, wherein said enrollment type comprises at least one of a particular category of students, a particular teacher's class, and a particular grade level.

12. The method of claim 1 wherein said predefined algorithm is further refineable using structured query language.

13. The method of claim 1 wherein said predefined algorithm is further refineable using a query builder.

14. The method of claim 1 further comprising sorting the materials according to customer-prescribed criteria.

15. The method of claim 1 wherein said quantities of said material are automatically adjusted to provide a user-specified overage amount for said quantity of materials.

16. The method of claim 15 wherein said overage amount is a fixed quantity of materials.

17. The method of claim 15 wherein said overage amount is a fixed percentage of said quantity of materials.

18. The method of claim 1 wherein said menu includes at least one of (a) an algorithm allowing a user to send a quantity of a selected material to all sites associated with the customer, (b) an algorithm allowing a user to send a quantity of a selected material to specific types of sites associated with the customer, (c) an algorithm allowing a user to send a quantity of a selected material to selected enrollment types,(d) an algorithm allowing a user to send a quantity of a selected material based on the quantity of another material sent, (e) an algorithm allowing a user to send a quantity of a selected material to any number of selected enrollment types divided by the number of students at each site enrolled in the selected enrollment type, (f) an algorithm allowing a user to send a quantity of selected material to any number of selected enrollment and group types, and (g) an algorithm allowing a user to send a quantity of a selected material to any number of selected enrollment and group types and divide that by a number of students enrolled in the selected group type and enrollment type.

19. A computer readable medium having instructions encoded thereon for causing an electronic computer system to implement a method for fulfilling a customer request for materials, said method comprising:
providing a list of materials from which a user can create a list of required materials;
providing a menu of predefined materials distribution algorithms from which a user can select a materials distribution algorithm to be applied to an associated material;
applying the selected materials distribution algorithm to the associated material in said list of required materials; and
creating a complete order of quantities of said materials as determined by said materials distribution algorithms applied to each of said associated materials.

20. The computer readable medium of claim 19 wherein said menu of predefined algorithms includes at least one of the following:
(a) X per site;
(b) X per selected site type;
(c) X per enrollment type;
(d) X per Y parts sent;
(e) X per virtual classroom;
(f) X per enrollment type divided by Z;
(g) X per enrollment type per group type; and
(h) X per enrollment type per group type divided by Z, wherein “X” is a number of materials defined by the predefined materials distribution algorithm, “Y” is a number of other materials used as a parameter in the predefined materials distribution algorithm, and “Z” is a number of individuals enrolled in the enrollment type or group type.

21. A method for fulfilling a customer request for education test materials, said method comprising the steps of:
defining a list of test materials necessary to fulfill said request;
constructing a test materials distribution algorithm for each material; and
fulfilling said request by sending quantities of said test materials as determined by each said test materials distribution algorithm;
wherein said test materials distribution algorithm is constructed by selecting a predefined algorithm from a menu comprising at least one of the following predefined algorithms:
(a) X per site;
(b) X per selected site type;
(c) X per enrollment type;
(d) X per Y parts sent;
(e) X per virtual classroom;
(f) X per enrollment type divided by Z;
(g) X per enrollment type per group type; and
(h) X per enrollment type per group type divided by Z,
wherein “X” is a number of materials defined by the predefined materials distribution algorithm, “Y” is a number of other materials used as a parameter in the predefined materials distribution algorithm, and “Z” is a number of individuals enrolled in the enrollment type or group type.

22. The method according to claim 21, wherein said test materials comprise one or more items selected from the group comprising middle school test booklets, high school test booklets, middle school answer sheets, high school answer sheets, test administrator guides, answer sheet envelopes, and teacher guides.

23. The method according to claim 21, wherein said types of sites comprise schools or school districts.

24. The method according to claim 21, wherein said enrollment type comprises at least one of a particular category of students, a particular teacher's class, and a particular grade level.

25. A method for fulfilling a customer request for education test materials, said method comprising the steps of:
defining a list of test materials necessary to fulfill said request;
constructing a test materials distribution algorithm for each material; and
fulfilling said request by sending quantities of said test materials as determined by each said test materials distribution algorithm;
wherein said test materials distribution algorithm is constructed by selecting a predefined algorithm from a menu of predefined algorithms comprising at least one of (a) an algorithm allowing a user to send a quantity of a selected material to all sites associated with he customer, (b) an algorithm allowing a user to send a quantity of a selected material to specific types of sites associated with the customer, (c) an algorithm allowing a user to send a quantity of a selected material to selected enrollment types,(d) an algorithm allowing a user to send a quantity of a selected material based on the quantity of another material sent, (e) an algorithm allowing a user to send a quantity of a selected material to any number of selected enrollment types divided by the number of students at each site enrolled in the selected enrollment type, (f) an algorithm allowing a user to send a quantity of selected material to any number of selected enrollment and group types, and (g) an algorithm allowing a user to send a quantity of a selected material to any number of selected enrollment and group types and divide that by a number of students enrolled in the selected enrollment type and group type.
